(19) United States
(12) Patent Application Publication
(10) Pub. No.: US 2026/0331962 A1
(43) Pub. Date: Oct. 22, 2026

(54) A WIRELESSLY-CHARGED ENERGY STORAGE DEVICE

(71) Applicant: WAVEN LIMITED LIABILITY COMPANY, Torun (PL)

(72) Inventors: Kamil CISZAK, Antoninow (PL); Lukasz CEJROWSKI, Wloclawek (PL); Rafal JAKUBOWSKI, Chelmno (PL); Artur PINDRAL, Lodz (PL); Mateusz JOZEFOWICZ, Torun (PL)

(73) Assignee: WAVEN LIMITED LIABILITY COMPANY, Torun (PL)

(21) Appl. No.: 19/105,701

(22) PCT Filed: Aug. 9, 2023
(86) PCT No.: PCT/PL2023/050065

§ 371 Date: Feb. 21, 2025

(30) Foreign Application Priority Data
Aug. 23, 2022 (PL) P.442076

(51) Int. Cl. H02J 50/27; H01Q 1/24; H01Q 1/36; H01Q 1/38; H02J 50/00; H02J 50/40

(52) U.S. Cl. CPC H02J 50/27; H01Q 1/248; H01Q 1/364; H01Q 1/38; H02J 50/001; H02J 50/005; H02J 50/402

(57) ABSTRACT

The invention is an energy storage device charged wirelessly, especially by collecting electromagnetic waves in the radio frequency. The device is characterized in that the casing is made of a dielectric material with a dielectric constant in the range from 2 to 5 and a wall thickness from 0.5 mm to 15 mm. At least one layer of strip antennas made of conductive material is applied to the outer surface of the casing, with successive layers of antennas separated by a layer of dielectric material. Inside the casing casing guides are made, into which a PCB with a system converting RF energy into DC is inserted. Terminals connecting at least one energy storage module to the terminals of the system converting RF energy into DC and contacts are embedded on the PCB, to which at least one antenna is connected.

### BACKGROUND

### Technical Field

The invention is an energy storage device charged wirelessly, especially by collecting electromagnetic waves in the radio frequency.

### Prior Art

A wirelessly charged battery known from the US Patent No U.S. Pat. No. 11,043,833 includes: a casing configured in dimensions corresponding to the standardized dimensions of batteries; one or more antennas placed in the casing, antennas configured to receive radio frequency (RF) wireless power from a wireless charging system; one or more electronic circuit boards placed in the casing, one or more electronic circuit boards configured to convert the received RF wireless power into direct current (DC) power; and one or more battery modules configured to store the DC power; characterized in that one or more antennas have configurable polarization, and the wirelessly charged battery device is configured to determine and configure the optimal polarization of one or more antennas by: for each of several antenna polarization modes—configuring one or more antennas based on the relevant antenna polarization mode and measuring the amount of received wireless power; and selecting for each antenna the antenna polarization mode that has the greatest amount of measured wireless power, to be the optimal antenna polarization.

An international PCT patent application No WO2021173676A1 describes a housing for a wirelessly charged battery including a casing having a base and an opposite open end, in which a hole is drilled in the base. The housing includes an end piece attached to the housing near the base and having an opposite open end. The housing includes a first conductive coating formed on the inner surface of the casing and the first surface of the base and a second conductive coating formed on the inner surface of the end piece and the second surface of the base, where the casing and the end pieces are configured in dimensions consistent with the standardized dimensions of batteries. The batteries are placed inside a cavity in the casing, and the circuits are placed inside a cavity of the end piece.

### SUMMARY OF THE INVENTION

In accordance with the present invention, the casing is made of a dielectric material with a dielectric constant in the range from 2 to 5 and a wall thickness from 0.5 mm to 15 mm, and at least one layer of strip antennas made of conductive material is applied to the outer surface of the casing, with successive layers of antennas separated by a layer of dielectric material. Inside the casing guides are made, into which a PCB with a system converting RF energy into DC is inserted. Terminals connecting at least one energy storage module to the terminals of the system converting RF energy into DC and contacts are embedded on the PCB, to which at least one antenna is connected.

Preferably, one of the poles of the antenna is embedded on the outer surface of the casing, the mass of which is embedded inside the casing and connected to the ground of the RF to DC energy conversion system, the antennas being equipped with contacts delivering the signal to the matching input the RF to DC energy conversion system and its ground. The geometry of the antennas and the thickness and dielectric constant of the casing material determine the width of the radio wave absorption range.

Preferably, the dielectric material is a plastic selected from the group: Teflon, silicone, PS, PP, ABS, PVC, PE, and rubber.

Advantageously, the casing is a spatial figure with a cross-section selected from the group: comprising a polygon and ellipse, advantageously a circle.

Preferably, at least one wall of the casing is corrugated at the top, preferably throughout its height.

Preferably, the antenna has a length corresponding to λ/2n, where λ is the length of the electromagnetic wave and n is an integer or the antenna has fractal lengths corresponding to λ/2n with an ultra-wideband antenna matching.

Preferably, the antenna is made of a composition containing a conductive material selected from the group: silver, copper, aluminum, tin, graphite, graphene, applied to the outer surface of the housing by printing technology.

Preferably, the antenna is made of a composition containing a conductive material selected from the group: silver, copper, aluminum, tin, graphite, graphene, applied to a dielectric substrate in the form of a self-adhesive sticker attached to the outer surface of the casing.

Preferably, the composition contains a conductive material selected from a group containing alloys of: silver, copper, aluminum, tin, graphite, graphene.

Preferably, the casing is corrugated, onto which packed conductive paths are applied, constituting antennas with an increased frequency range of received radio waves.

Preferably, the antenna is made in the form of a meander or a wavy line.

Preferably, the printed circuit board with the RF to DC energy conversion system is a spring-loaded PCB, with only relevant conductive elements on the board and removed additional conductive elements.

Preferably, there is a free space inside the casing for tuning the radio wave absorption bands and matching the antenna input impedance, the dimensions and geometry of which are determined based on the ratio of casing dimensions, thickness of casing walls and the dielectric constant of the casing material.

Preferably, the free space inside the casing is distributed along the entire length of the casing, or the free space inside the casing surrounds the energy storage module along its entire length, or the free space inside the casing is situated above and below the energy storage module.

Preferably, the energy storage module is so situated in the free space that it does not disturb the absorption band of radio waves and the matching impedance of antenna input.

Preferably, the energy storage module contains at least one battery and/or at least one supercapacitor.

Preferably, the PCB and antenna are made in Rigid-Flex PCB technology, where the PCB is made in Rigid PCB technology and the antenna is made in the aforementioned Flex PCB technology and directly connected to the circuit of the PCB, in addition, the antenna is glued to the outer surface of the casing.

Preferably, the antenna made in the aforementioned Flex PCB technology is in the form of a self-adhesive sticker.

The energy storage device according to the invention allows for wireless delivery of energy to energy storage systems, especially devices located in hard-to-reach places, or where charging via cables is impossible. It also creates the possibility of charging energy storage devices that are found in many devices without the need to remove them. The device enables the collection of electromagnetic radiation smog and using it to charge the energy storage system. Moreover, the device allows for continuous and uninterrupted charging of the energy storage system, even when it is not being used, in order to extend the lifespan of the potentially used batteries, which lose their lifespan due to the self-discharge process. This allows for the elimination of conventional batteries and the replacement of low-energy device power systems with energy harvesting and storage systems to reduce environmental pollution from used and still toxic batteries.

### BRIEF DESCRIPTION OF DRAWING

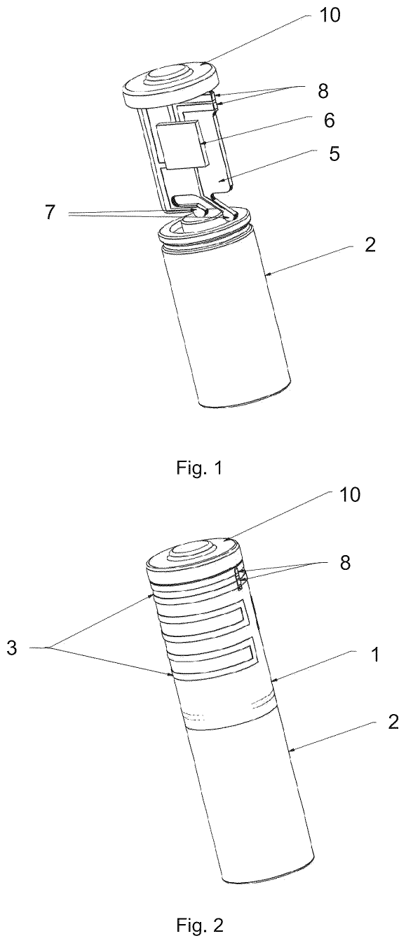

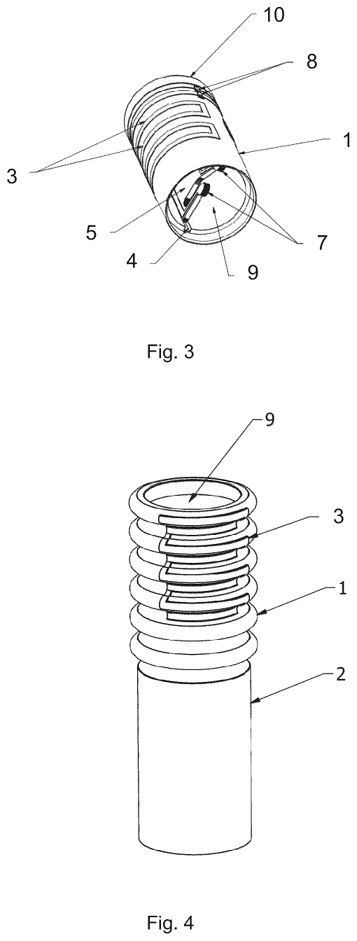

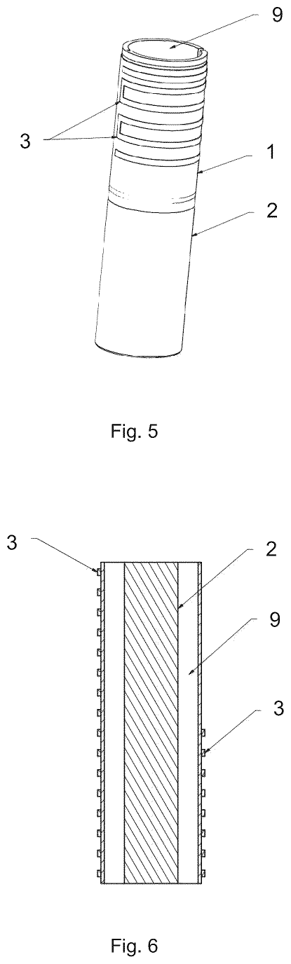

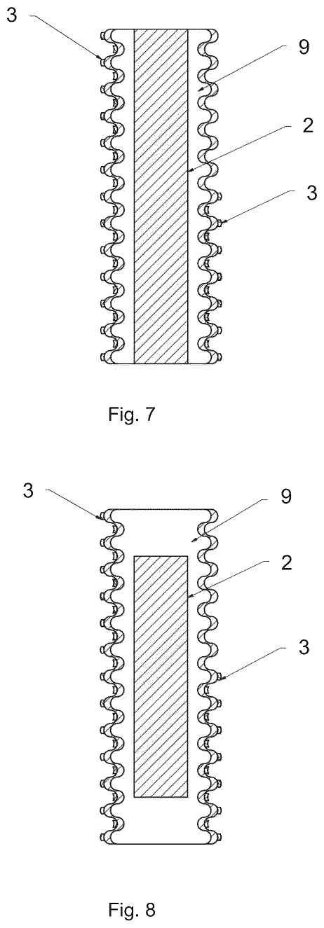

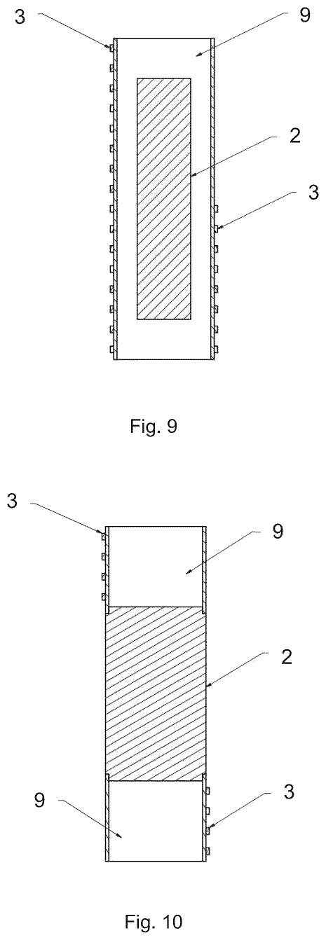

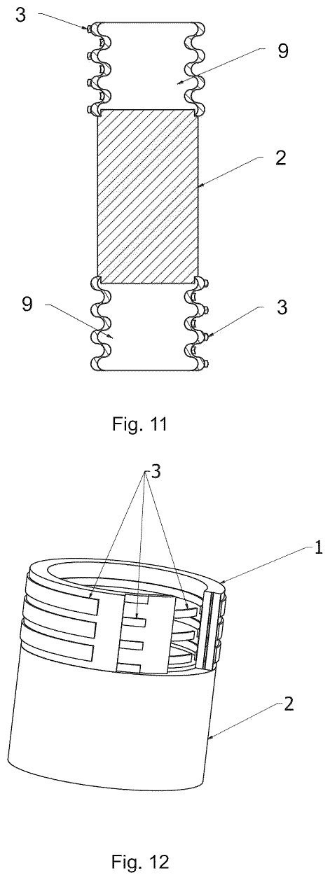

The subject of the invention in the embodiment is illustrated in the drawing, in which FIG. 1 shows a wirelessly charged electrical energy storage device without a casing in an axonometric view, FIG. 2—a wirelessly charged electrical energy storage device with a casing in an axonometric view, FIG. 3—axonometric view of the PCB printed circuit board inside the casing, FIG. 4—axonometric view of the casing with a meandering antenna applied to its corrugated side surface, FIG. 5—axonometric view of the casing with a meandering antenna applied to its cylindrical side surface, FIG. 6—vertical section of the casing with straight side walls with the energy storage module distributed over the entire height of the casing in free space and antennas applied from the first side to the entire height of the casing, and from the second side to half the height, in a schematic view, FIG. 7—vertical section of the casing with corrugated walls with the energy storage module distributed over the entire height of the casing in free space and antennas applied to the entire height of the casing, in a schematic view, FIG. 8—vertical section of the casing with corrugated walls with the energy storage module symmetrically arranged inside the casing and antennas applied to the entire height of the casing, in a schematic view, FIG. 9—vertical section of the casing with straight side walls with the energy storage module symmetrically arranged inside the casing in free space and antennas applied from the first side to the entire height of the casing, and from the second side to half the height, in a schematic view, FIG. 10—vertical section of the casing with straight side walls with the energy storage module abutting the casing with free spaces located above and below the energy storage module and antennas applied from the first side to the height of the casing above the energy storage module, and from the second side to the height of the casing above the energy storage module, in a schematic view, FIG. 11—vertical section of the housing with the energy storage module abutting the casing with corrugated side walls above and below the energy storage module with free spaces located above and below the energy storage module and antennas applied to the corrugated side walls, and FIG. 12—three layers of strip antennas made of conductive material separated by two layers of dielectric material.

### DETAILED DESCRIPTION OF THE PREFERRED EMBODIMENT OF THE INVENTION

### Example 1

The device for wirelessly charging and storing electric energy includes a casing 1, in which an energy storage module 2 is embedded, connected to a RF to DC energy conversion system 6 with two antennas 3. The casing 1 is made of a dielectric material, specifically Teflon, with a dielectric constant of 2 and a wall thickness of 0.5 mm. The casing 1 is a three-dimensional shape with a constant cross-section that is a circle. In addition, the top of the casing is closed with a cover equipped with a positive pole of the device 10, and the bottom is closed with the energy storage module 2. Two strip antennas 3 made of a conductive material are applied to the outer surface of the casing 1. Inside the casing 1, casing guides 4 are created, into which a printed circuit board PCB 5 with the RF to DC energy conversion system 6 is inserted. On the printed circuit board PCB 5, there are terminals 7 connecting the energy storage module 2 with the terminals 7 of the RF to DC energy conversion system, and on the printed circuit board PCB 5, contacts 8 are made, to which the antennas 3 are connected. On the outer surface of the casing 1, one of the poles of the antenna 3 is mounted, whose mass is embedded inside the casing 1 and is connected to the mass of the RF to DC energy conversion system 6. The antennas 3 are equipped with contacts 8 bringing the signal to the input of the RF to DC energy conversion system 6 and its mass. The geometry of the antennas 3 and the thickness and dielectric constant of the casing 1 material determine the width of the radio wave absorption range. The antennas 3 have a length corresponding to λ/2, where λ is the wavelength of the electromagnetic wave and are made of a composition containing silver, applied to the outer surface of the casing 1 by screen printing technology. The energy storage module 2 is a battery, which is so located in the free space 9 that it does not disturb the radio wave absorption band and matches the input impedance of the antenna 3.

### Example 2

The device for wirelessly charging and storing electric energy is made as in the first example, with the difference that the casing 1 is made of ABS dielectric material with a dielectric constant of 3.3 and a wall thickness of 15 mm, and four strip antennas 3 made of a conductive material in the form of a composition containing copper as a conductive material are applied to the outer surface of the casing 1. In addition, the antennas 3 have a length corresponding to λ/2n, where λ is the wavelength of the electromagnetic wave, and n is an integer and equals 3. The casing 1 is a cylindrical three-dimensional shape with a circular cross-section and is made of ABS as a dielectric material with a dielectric constant of 3.3, and has a corrugated upper side surface. Additionally, packed conductive tracks constituting antennas 3 with an extended frequency range of received radio waves are applied to the casing 1.

### Example 3

The device for wirelessly charging and storing electric energy is made in the same way as in the first example, but with the difference that the casing 1 is made of a dielectric material in the form of silicone with a dielectric constant of 10 and a wall thickness of 15 mm. Six strip antennas 3 are applied to the outer surface of the housing 1, made of a conductive material in the form of a composition containing aluminum as the conductive material. In addition, antenna 3 has a length corresponding to λ/2n, where λ is the length of the electromagnetic wave, and n is an integer and equals 2. Antenna 3 is made of a composition containing copper as a conductive material. Casing 1 is a cylindrical spatial figure with an elliptical cross-section and is made of silicone with a dielectric constant of 10. A printed circuit board with a circuit converting RF energy to DC is a spring-loaded printed circuit board 5 (PCB), on which only the relevant conductive elements are present, and additional conductive elements have been removed. Moreover, the antenna 3 has fractal lengths corresponding to λ/2n with an ultra-wideband matching of antenna 3.

### Example 4

The device for wirelessly charging and storing electric energy is made in the same way as in the examples from the first to the third, with the difference that inside the casing 1 there is a free space 9 for tuning the absorption bands of radio waves and matching the input impedance of the antenna 3, the dimensions and geometry of which are determined based on the ratio of the dimensions of the casing 1, the thickness of the casing walls 1, and the dielectric constant of the casing material 1. In addition, a self-adhesive sticker is attached to the outer surface of the casing 1 with antennas 3 applied to the dielectric substrate.

### Example 5

The device for wirelessly charging and storing electric energy is made in the same way as in the fourth example, but with the difference that in the casing 1 with straight side walls, an energy storage module 2 is placed throughout the height of the casing 1 in free space 9, while the antennas 3 are applied from the first side throughout the height of the casing 1, and from the second side to half of its height.

### Example 6

The device for wirelessly charging and storing electric energy is made in the same way as in the fourth example, but with the difference that in the casing 1 with corrugated walls, an energy storage module 2 is placed throughout the height of the casing in the free space, and the antennas 3 are applied to the entire height of the casing.

### Example 7

The device for wirelessly charging and storing electric energy is made in the same way as in the fourth example, but with the difference that in the casing 1 with corrugated walls, the energy storage module 2 is symmetrically placed inside the casing, and the antennas 3 are applied throughout the height of the casing 1.

### Example 8

The device for wirelessly charging and storing electric energy is made in the same way as in the fourth example, but with the difference that in the casing 1 with straight side walls, an energy storage module 2 is symmetrically placed inside the casing, while the antennas 3 are applied from the first side throughout the height of the casing, and from the second side to half of its height.

### Example 9

The device for wirelessly charging and storing electric energy is made in the same way as in the fourth example, but with the difference that in the casing 1 with straight side walls, the energy storage module 2 is adjacent to the casing with free spaces placed above and below the energy storage module 2. Antennas are applied to the casing from the first side to the height of the casing 1 above the energy storage module 2, and from the second side to the height of the casing 1 above the energy storage module 2.

### Example 10

The device for wirelessly charging and storing electric energy is made in the same way as in the fourth example, but with the difference that the energy storage module 2 is adjacent to the casing 1, which has corrugated side walls above and below the energy storage module 2 with free spaces placed above and below the energy storage module 2, while the antennas are applied to the corrugated side walls.

### Example 11

The device for wirelessly charging and storing electric energy is made in the same way as in the examples from the first to the third, but with the difference that the antenna 3 is made in the form of a wavy line.

### Example 12

The device for wirelessly charging and storing electric energy is made in the same way as in the examples from the first to the third, but with the difference that the energy storage module 2 is a battery.

### Example 13

The device for wirelessly charging and storing electric energy is made in the same way as in the examples from the first to the third, but with the difference that the energy storage module 2 is a supercapacitor.

### Example 14

The device for wirelessly charging and storing electric energy is made in the same way as in the examples from the first to the third, but with the difference that the energy storage module 2 is three batteries.

### Example 15

The device for wirelessly charging and storing electric energy is made in the same way as in the examples from the first to the third, but with the difference that the energy storage module 2 is five supercapacitors.

### Example 16

The device for wirelessly charging and storing electric energy is made in the same way as in the examples from the first to the third, with the difference that the printed circuit board PCB 5 and antenna 3 are made using Rigid-Flex PCB technology. The PCB 5 is made using Rigid PCB technology, and the antenna 3 is made using Flex PCB technology and is directly connected to the circuit of the PCB 5. Moreover, antenna 3 is glued onto the outer surface of casing 1.

### Example 17

The device for wirelessly charging and storing electric energy is made in the same way as in the sixteenth example, but with the difference that the antenna 3, made using Flex PCB technology, is in the form of a self-adhesive sticker.

### Example 18

The device for wirelessly charging and storing electric energy is made in the same way as in the examples from the first to the third, but with the difference that three layers of strip antennas 3, made of conductive material, are applied to the outer surface of the casing 1. Successive layers of antennas 3 are separated by a layer of dielectric material.

The device for wirelessly charging and storing electric energy has a casing 1 made of any dielectric plastic material with a dielectric constant in the range of 2 to 10, in particular, such materials as: silicone, Teflon, ABS, PVC, PE, PS, PP, and rubber. Antennas 3, made from a composition containing a conductive material selected from a group: silver, copper, aluminum, tin, graphite, graphene, as well as their alloys and mixtures, are applied to the dielectric housing. Antenna 3 can be made in the form of a self-adhesive sticker, which has a dielectric substrate with a composition containing a conductive material such as selected from a group: silver, copper, aluminum, tin, graphite, graphene, as well as their alloys and mixtures applied. The composition is applied to a dielectric substrate in the form of a self-adhesive sticker that is glued to the outer surface of casing 1. The device according to the invention allows for the collection of electromagnetic waves from the range of radio waves, then the absorbed electromagnetic wave energy is converted into low voltage direct current. Subsequently, the built-in converter circuit increases the voltage of the absorbed charge and charges the energy storage module 2 to a set voltage, which is most often a battery, capacitor, supercapacitor, etc.

### INDEX OF SYMBOLS IN THE DRAWING

1. Casing
2. Energy storage module
3. Antenna
4. Casing guide
5. Printed circuit board PCB
6. RF to DC energy conversion circuit
7. Terminals
8. Contact
9. Free space
10. Positive pole of the device

1. The wirelessly charged energy storage device comprising: a casing, an energy storage module, a system for harvesting electromagnetic energy from the environment that converts RF energy into DC, to which at least two antennas are connected, moreover, the system for harvesting electromagnetic energy from the environment has charging connectors, wherein the casing is made of a dielectric material with a dielectric constant in the range from 2 to 5 and a wall thickness from 0.5 mm to 15 mm, and at least one layer of strip antennas made of conductive material is applied to the outer surface of the casing, with successive layers of antennas separated by a layer of dielectric material; inside the casing casing guides are made, into which a PCB with a system converting RF energy into DC is inserted, moreover, terminals connecting at least one energy storage module to the terminals of the system converting RF energy into DC and contacts are embedded on the PCB, to which at least one antenna is connected.

2. The device, according to claim 1, wherein one of the poles of the antenna is mounted on the outer surface of the casing, the mass of which is mounted inside the casing and connected to the ground of the system converting RF energy into DC, and the antennas are equipped with contacts leading the signal to the input matching of the system converting RF energy into DC and its ground, the geometry of the antennas and the thickness and dielectric constant of the casing material determine the width of the radio wave absorption range.

3. The device, according to claim 1, wherein the dielectric material is a plastic selected from the group: silicone, Teflon, ABS, PVC, PE, PS, PP, and rubber.

4. The device, according to claim 1, wherein the casing is a three-dimensional figure with a cross-section selected from a group: comprising a polygon, an ellipse, and a circle.

5. The device, according to claim 1, wherein at least one wall of the casing is corrugated at the top throughout its height.

6. The device, according to claim 1, wherein the antenna has a length corresponding to λ/2n, where λ is the length of the electromagnetic wave, and n is an integer.

7. The device, according to claim 6, wherein the antenna has fractal lengths corresponding to λ/2n with ultra-wideband antenna matching.

8. The device, according to claim 1, wherein the antenna is made of a composition containing a conductive material selected from the group: silver, copper, aluminum, tin, graphite, and graphene, applied to the outer surface of the casing by printing technology.

9. The device, according to claim 1, wherein the antenna is made of a composition containing a conductive material selected from the group: silver, copper, aluminum, tin, graphite, graphene, applied to a dielectric substrate in the form of a self-adhesive sticker glued to the outer surface of the casing.

10. The device, according to claim 8, wherein the composition contains a conductive material selected from the group comprising alloys: silver, copper, aluminum, tin, graphite, and graphene.

11. The device, according to claim 1, wherein the casing is corrugated, on which conducting paths forming antennas with an increased range of received radio wave frequencies are applied.

12. The device, according to claim 1, wherein the antenna is made in the form of a meander.

13. The device, according to claim 1, wherein the antenna is made in the form of a wavy line.

14. The device, according to claim 1, wherein the printed circuit board with the system converting RF energy into DC is a spring-loaded PCB, on which there are only essential conducting elements, and additional conducting elements have been removed.

15. The device, according to claim 1, wherein inside the casing there is a free space tuning the absorption bands of radio waves and matching the input impedance of the antenna, whose dimensions and geometry are determined based on the ratio of the dimensions of the casing, the thickness of the casing walls, and the dielectric constant of the casing material.

16. The device, according to claim 15, wherein the free space inside the casing is distributed along the entire length of the casing.

17. The device, according to claim 15, wherein the free space inside the casing surrounds the energy storage module along its entire length.

18. The device, according to claim 17, wherein the free space inside the casing is located above and below the energy storage module.

19. The device, according to claim 15, wherein the energy storage module is positioned in the free space so as not to disrupt the absorption band of radio waves and matching the input impedance of the antenna.

20. The device, according to claim 1, wherein the energy storage module contains at least one battery and/or at least one supercapacitor.

21. The device, according to claim 1, wherein the PCB and antenna are made in Rigid-Flex PCB technology, with the PCB made in Rigid PCB technology and the antenna made in Flex PCB technology and connected directly to the circuit of the PCB, in addition, the antenna is glued to the outer surface of the casing.

22. The device, according to claim 21, wherein the antenna made in Flex PCB technology has the form of a self-adhesive sticker.

23. The device, according to claim 9, wherein the composition contains a conductive material selected from the group comprising alloys: silver, copper, tin, graphite, and graphene.
